(19) United States
(12) Patent Application Publication
(10) Pub. No.: US 2026/0105057 A1
(43) Pub. Date: Apr. 16, 2026

(54) CONTEXT-AWARE ARTIFICIAL INTELLIGENCE VIRTUAL ASSISTANT

(71) Applicant: Adobe Inc., San Jose, CA (US)

(72) Inventors: Lokendra Singh Chauhan, Bangalore (IN); Sanjana Sagi, Bangalore (IN); Rajkumar Shinde, Bengaluru (IN); Pierre Tager, San Francisco, CA (US); Aditi Pendse, San Jose, CA (US)

(73) Assignee: Adobe Inc., San Jose, CA (US)

(21) Appl. No.: 18/916,380

(22) Filed: Oct. 15, 2024

(51) Int. Cl. G06F 16/248; G06F 16/242

(52) U.S. Cl. CPC G06F 16/248; G06F 16/243

(57) ABSTRACT

Techniques and systems for context-aware AI virtual assistance are described to enable efficient querying of data for answers, subscription assistance, support links, and event history summaries. In an example, a processing device is operable to receive an input including a query related to support services for one or more products. The processing device then queries a machine-learning model using the query and the context of the query, which includes a subscription status of a user for the one or more products. A result that includes an answer to the query based on the context is received from the machine-learning model. The processing device is operable to present the result for display in a user interface.

### BACKGROUND

Software providers often host support sites to offer information and resources for their software applications. These support sites provide visibility into product and service availability, operational incidents (e.g., system or feature outages), maintenance information, and upcoming events. These resources help enterprise and non-enterprise customers anticipate the impact that software applications and the availability thereof may have on business operations. However, these support sites are often difficult to navigate. For example, support sites often include information irrelevant to a customer's subscriptions, subscription preferences, or usage history. Enterprise customers, in particular, expect assistance from software providers to quickly and in real-time anticipate impacts on their business operations due to software outages and general maintenance.

### SUMMARY

Techniques for context-aware artificial intelligence (AI) virtual assistance are described to enable efficient customer support related to one or more product subscriptions. In an example, a virtual assistance module leverages machine learning, such as a large language model, to consider a user query, including the context, intent, or sentiment associated with the user query, and query a data set and derive a personalized output inferred from the input. Based on the context, the machine-learning model provides users with personalized content to streamline support services. In this way, the machine-learning model quickly provides relevant updates to customers via personalized searches, text summaries, subscription management, and actionable recommendations. While conventional support services and assistants are tedious and time-consuming, the described virtual assistant module efficiently (e.g., with fewer user inputs) generates robust and personalized outputs to support-related questions.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRA WINGS

The detailed description is described with reference to the accompanying figures Entities represented in the figures are indicative of one or more entities and thus reference is made interchangeably to single or plural forms of the entities in the discussion.

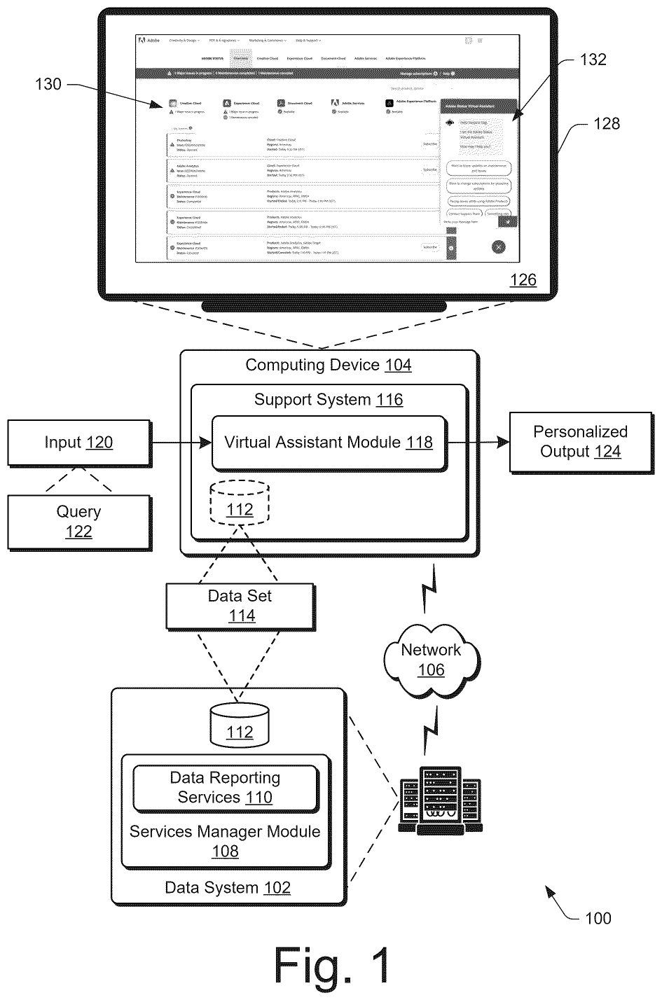

FIG. 1 is an illustration of an environment in an example implementation that is operable to employ a context-aware AI virtual assistant as described herein.

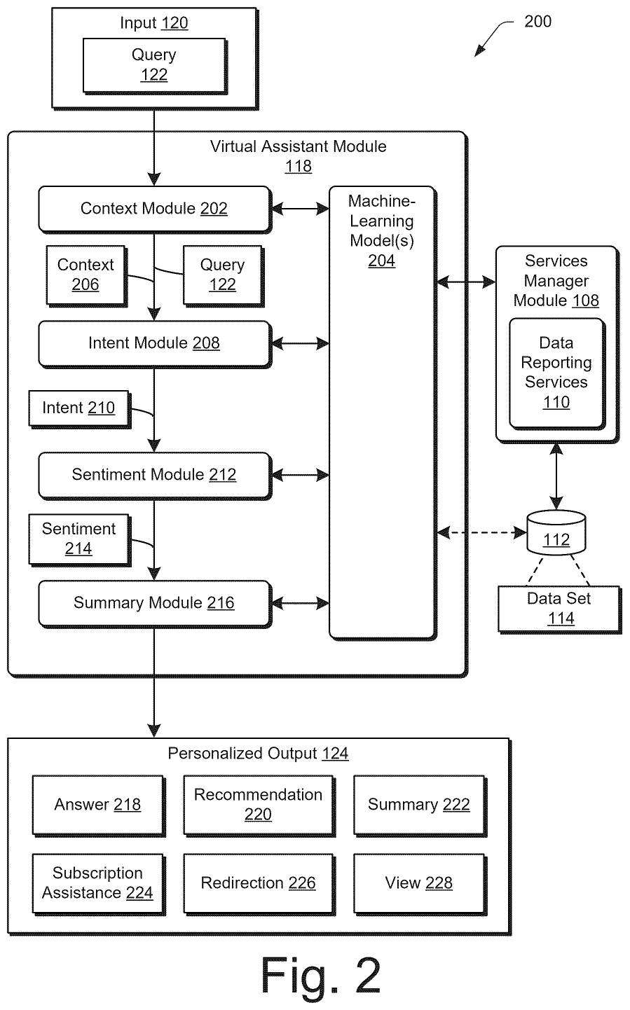

FIG. 2 depicts an example implementation of a virtual assistant module of FIG. 1 in greater detail as employing techniques described herein for a context-aware AI virtual assistant.

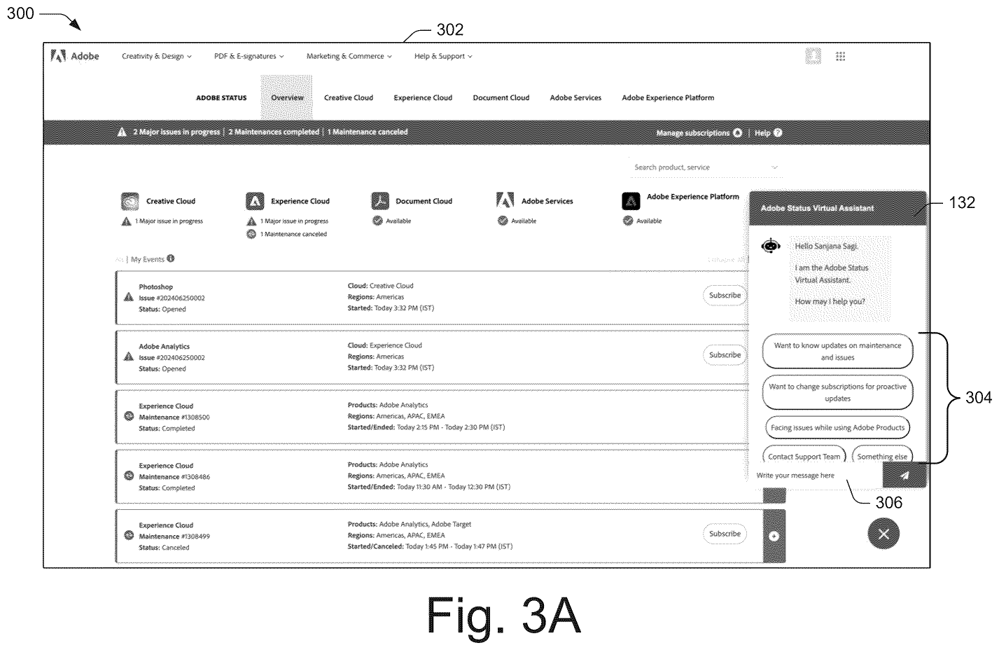

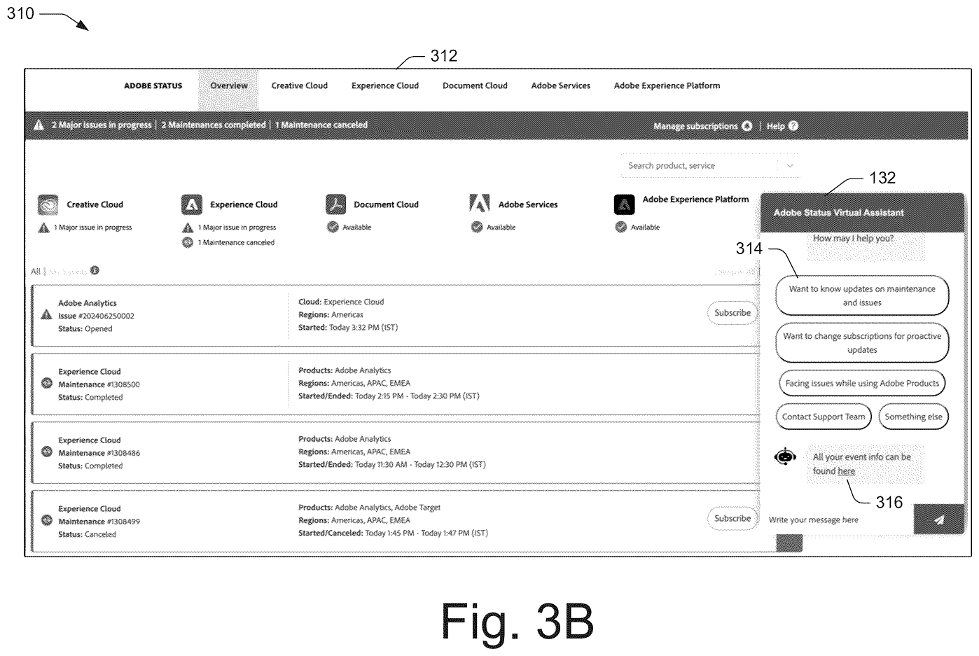

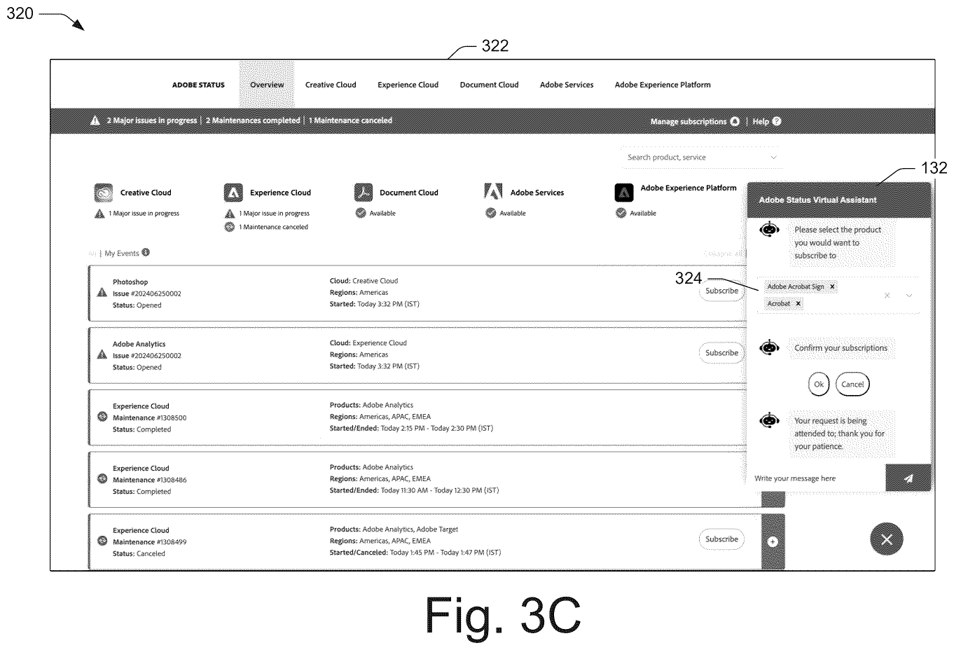

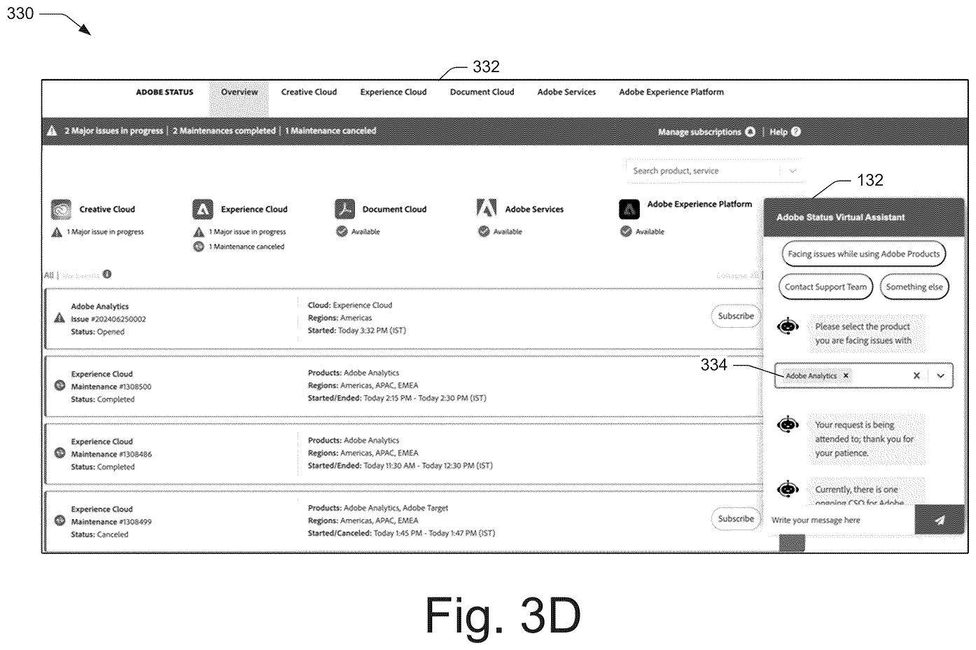

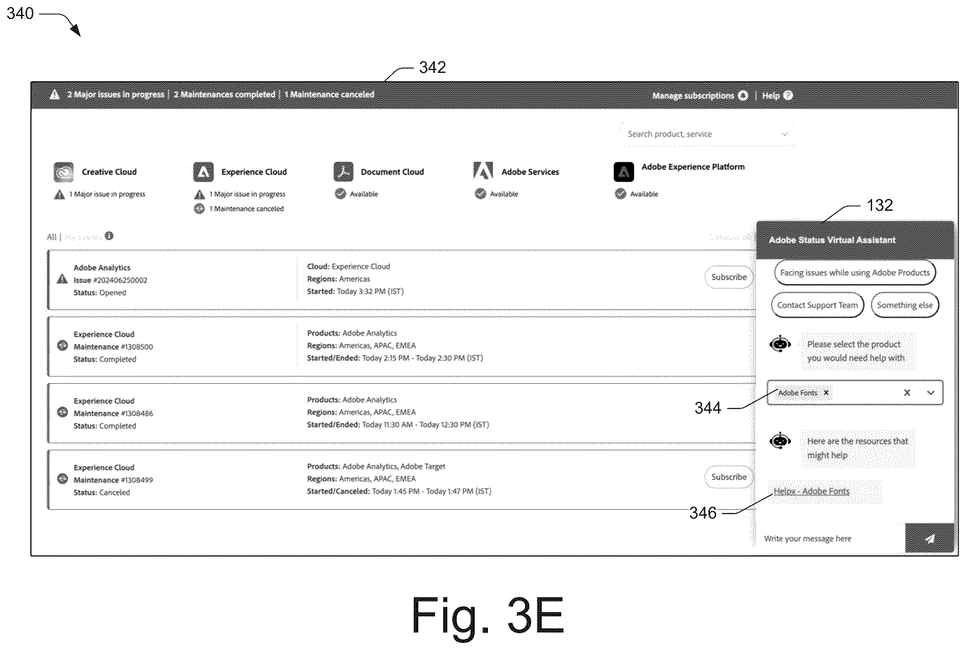

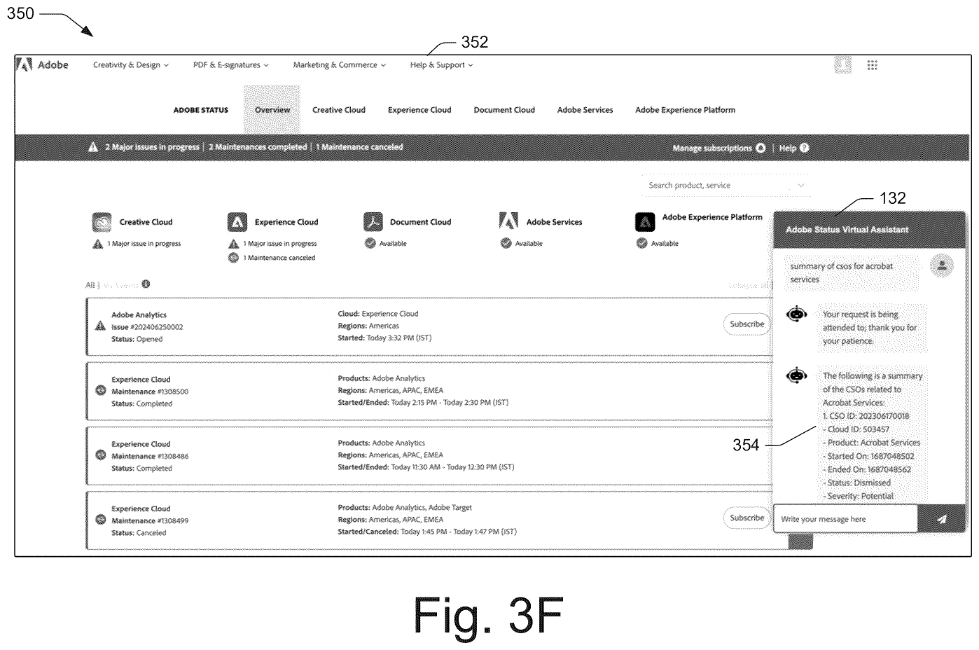

FIGS. 3A, 3B, 3C, 3D, 3E, and 3F illustrate examples of user interfaces for a context-aware AI virtual assistant as described herein.

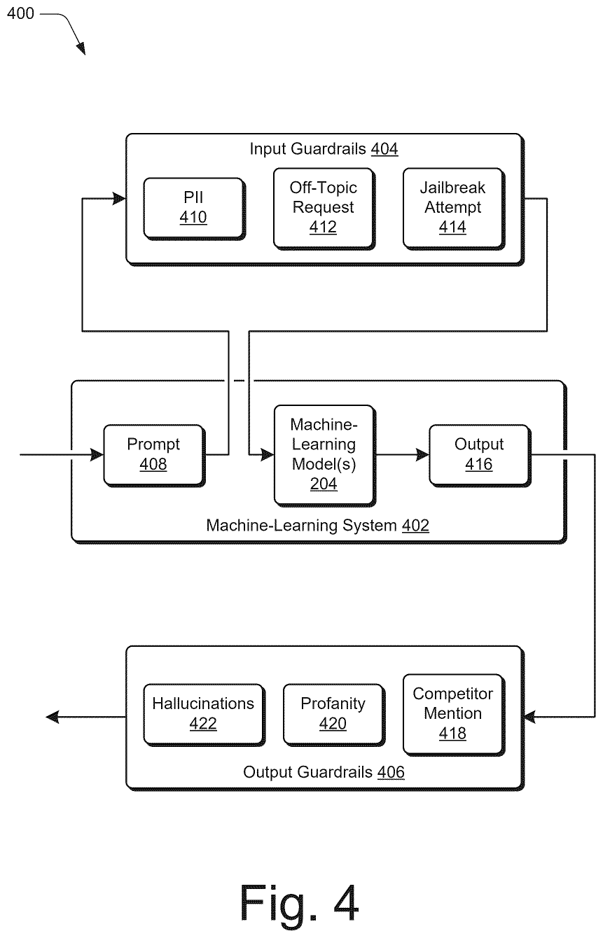

FIG. 4 illustrates an example implementation of guardrails for the context-aware AI virtual assistant as described herein.

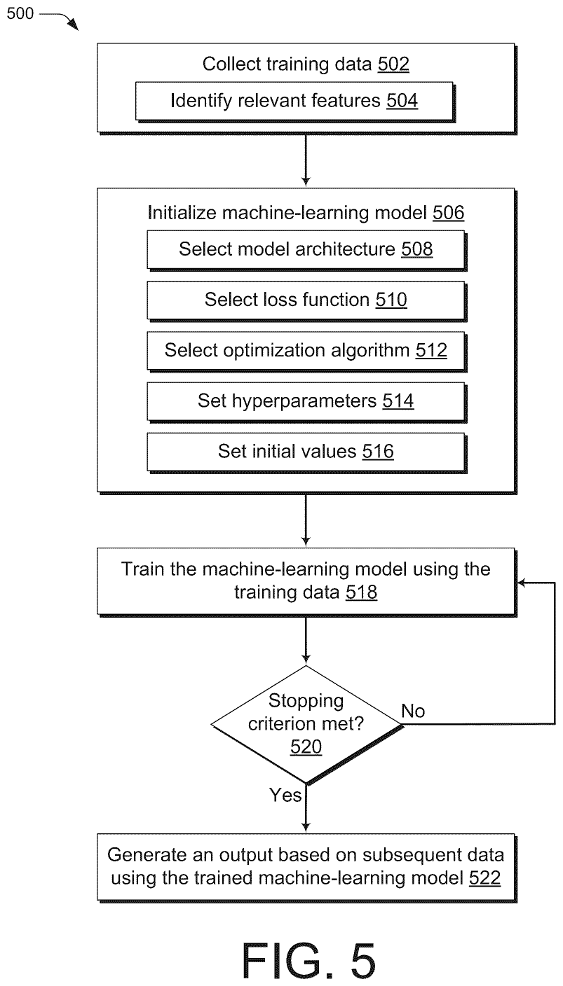

FIG. 5 is a flow diagram depicting an algorithm as a step-by-step procedure in an example implementation of operations performable for training a machine-learning model of the machine-learning system of FIG. 1.

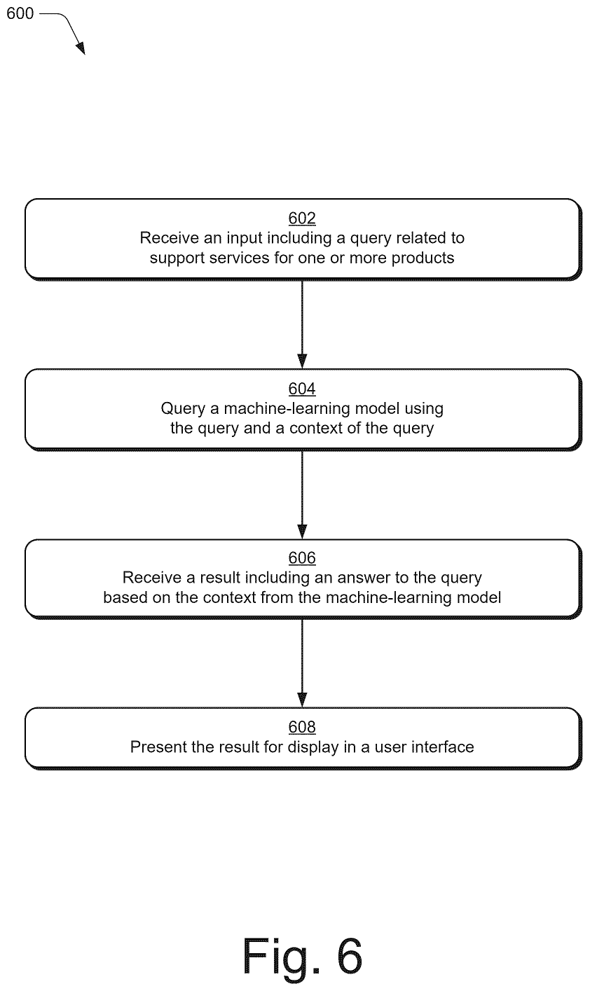

FIG. 6 is a flow diagram depicting a procedure in an example implementation for context-aware AI virtual assistance.

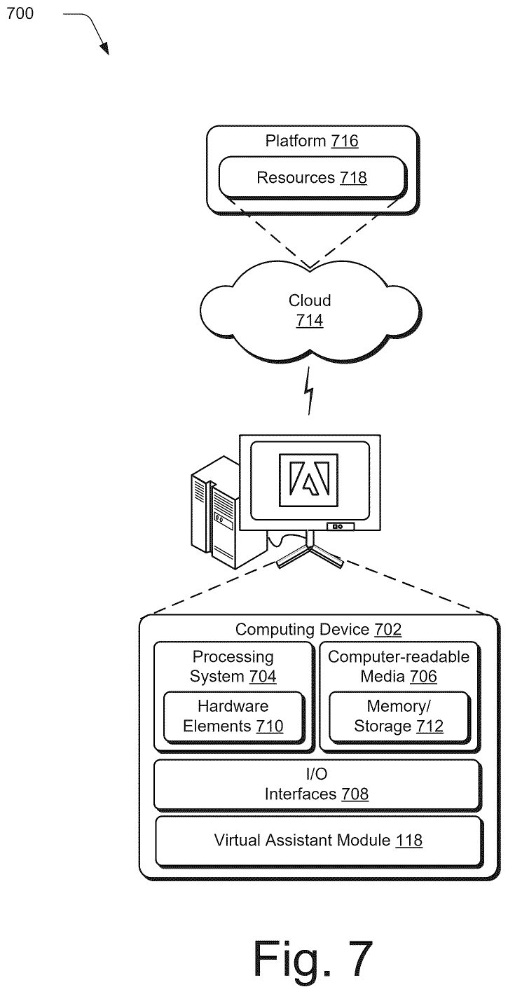

FIG. 7 illustrates an example system that includes an example computing device that is representative of one or more computing systems and/or devices for implementing the various techniques described herein.

### DETAILED DESCRIPTION

### Overview

As described above, software providers frequently offer a support website for customers to check the subscription status of their software applications and systems. These support sites also provide information about outages, disruptions, and maintenance events to help customers determine whether software issues are due to system problems or local factors. These support sites, however, can be challenging to navigate and include irrelevant information for the customer. In addition, reading and understanding event histories for a particular issue or maintenance event is time-consuming and not straightforward. To address these issues and provide customers with relevant updates and information more efficiently, this document describes techniques and systems for a context-aware AI virtual assistant that supports personalized search within the associated support site, text summarization of maintenance history, subscription management, and actionable recommendations.

Organizations, including software providers, are experiencing a service challenge to meet customers' demands for real-time content, expertise, and personalized solutions. One conventional approach is to offer virtual experts through chat features on an organization's website. These virtual experts are agents who engage with consumers to answer questions, provide recommendations, and offer advice in any location, at any time, and in any format. However, this conventional approach can be very expensive to establish and maintain, particularly for organizations with a large customer base.

Another conventional approach is to use AI agents (e.g., chatbots) as part of the chat feature. Conversational AI agents can maintain a dialogue with a customer on a wide range of topics but are generally not equipped or expected to provide precise information based on the conversation's and user's contexts. These conventional AI agents often implement a machine-learning model through static guided flows that do not adapt to the current context. As a result, customers often find it difficult and time-consuming to prompt the AI agents to provide the requested information.

In contrast, the described techniques and systems provide a context-aware AI virtual assistant. The described techniques enable a virtual assistant (e.g., chat interface) that provides task-oriented personalized customer interactions. In particular, the described techniques utilize cognitive processing to save customers valuable time when facing software issues and outages. In addition, the described virtual assistant helps enterprise customers anticipate business impacts and reduce critical escalations through customer care for the same problem reported by different customers.

Instead of conventional manual matching of user inputs in natural language, the described techniques map user inputs to relevant intents handled by task-based actions and pre-trained large language models (LLMs). The LLMs use machine-learning techniques to train semi-structured data for text summarization with positive tones and sentiment analysis. Validation is provided with prediction assessment for matching utterances with intents and guardrails to add controls on user inputs and system outputs.

In addition, the described techniques provide personalized LLMs for event searches and summarizations to understand business impacts. The virtual assistant also eliminates manual searching and filtering by customers by providing updates, recommendations, and information based on various filtering criteria (e.g., product entitlements, location, event type) specific to the customer. Personalized customer experience is also provided through page views and subscription recommendations based on history, service association, product entitlements, and feedback.

In the following discussion, an example environment is first described that employs examples of techniques described herein. Example procedures are also described which are performable in the example environment and other environments. Consequently, performance of the example procedures is not limited to the example environment and the example environment is not limited to performance of the example procedures.

### Virtual Assistance Environment

FIG. 1 illustrates an environment 100 in an example implementation that is operable to employ techniques for a context-aware AI virtual assistant as described herein. The illustrated environment 100 includes a data system 102 and a computing device 104 that are communicatively coupled, one to another, via a network 106.

The data system 102 and the computing device 104 are example computing systems that are configurable in a variety of ways. A computing system, for instance, is configurable as a desktop computer, a laptop computer, a mobile device (e.g., assuming a handheld configuration such as a tablet or mobile phone), and so forth. Thus, a computing system ranges from full resource devices with substantial memory and processor resources (e.g., personal computers, game consoles) to a low-resource device with limited memory and/or processing resources, e.g., mobile devices. Additionally, although separate, individual computing systems are shown and described in instances in the following discussion, each computing system is also representative of a plurality of different devices, such as multiple servers utilized by a business to perform operations “over the cloud” and as further described in relation to FIG. 7.

The data system 102 includes a services manager module 108 implemented using hardware and software resources (e.g., a processing device and computer-readable storage medium) of the data system 102 to support one or more data reporting services 110. The data reporting services 110 are made available remotely via network 106 to computing systems (e.g., computing device 104) to enable querying of data set 114 maintained by storage device 112.

Although, in this illustrated example, the storage device 112 is maintained locally at the data system 102, in other examples, the computing device 104 includes the storage device 112 to maintain the data set 114 (or a subset thereof) locally at the computing device 104. When the data set 114 is maintained locally at the computing device 104, aspects of the data system 102 (e.g., the services manager module 108, the data reporting services 110) are integrated within the computing device 104 to enable hardware and software resources on the computing device 104 to access the data set 114. The data set 114, for instance, is configurable as a knowledge source (e.g., using webpages, digital documents, digital audio, digital video, digital images, and so forth) that is accessible via a variety of entities, examples of which include databases, third-party systems, and so forth. The data set 114 also includes an intent corpus, which contains different keywords and utterances associated with a user's intent and is used to train a machine-learning model of the virtual assistant module 118.

The data reporting services 110 are scalable through implementation by the hardware and software resources of the data system 102 to support a variety of functionalities, including data accessibility, data verification, real-time data processing, data analytics, and so forth. Examples of the data reporting services 110 include a subscription service, user subscription profiles, customer support data, software community data, critical service outage (CSO) history data, change management request (CMR) (also sometimes referred to as change maintenance request) history data, update data, event history data, a data aggregation service, a data storage service, a data management service, a data analytics service, a project management service, a business management service, an accounting service, and so on.

Accordingly, in the illustrated example, access from the computing device 104 to the data reporting services 110 is utilized by a support system 116 of the computing device 104. A virtual assistant module 118 (e.g., application, browser, network-enabled application, chatbot, and so on) of the support system 116 accesses the data set 114 using the one or more data reporting services 110. The virtual assistant module 118, for instance, causes the computing device 104 to send a query over the network 106 to an interface with the services manager module 108 when the data reporting services 110 are implemented remotely. In another example, when the data reporting services 110 are implemented locally, the virtual assistant module 118 causes the computing device 104 to input the query directly within the services manager module 108.

The data reporting services 110 are configured to perform a function based on the query, such as identifying a user's subscriptions, determining relevant updates (e.g., CSOs, outages, issues, CMRs, maintenance), and loading announcements. A result generated by the data reporting services 110 based on querying the data set 114 is output from the services manager module 108. In one example, the result is output to the computing device 104 via the network 106. When the data reporting services 110 are implemented locally on the computing device 104, the services manager module 108 outputs the result directly to the support system 116 or the virtual assistant module 118, such as over an internal communication channel of the support system 116.

The virtual assistant module 118 is configurable to receive an input 120 (e.g., a natural language user input, a machine-generated input) that includes a query 122. Based on query 122, the virtual assistant module 118 generates a personalized output 124 (e.g., for display in a user interface 126 of a display device 128) from the support system 116. The virtual assistant module 118 handles customer interactions (e.g., queries 122) utilizing one or more machine-learning models (e.g., LLMs). For example, the virtual assistant module 118 trains machine-learning models using semi-structured data for text summarization with positive sentences and sentiment analysis. The virtual assistant module 118 also provides validation with prediction assessment for matching input utterances in the queries 122 with intent and guardrails to add controls on user inputs and system outputs. The personalized outputs 124 include, for example, notifications for subscription management, event updates, event summarizations, subscription assistance, and customer redirect to the appropriate support forums. The event types include CSO/Issue, CMR/Maintenance/Change, and Announcements.

As illustrated, the user interface 126 is displayed on a display device 128 of the computing device 104, and within the user interface 126, the query 122 and the personalized output 124 are displayed as multimedia information, e.g., textual responses, graphics, and/or a combination thereof. The user interface 126 is a graphical user interface in the illustrated example. In other examples, the user interface 126 is output as another type of user interface (e.g., an audible user interface through an audio output device, a haptic user interface through a haptic feedback device) or a combination of multiple user interface types and output devices.

In one implementation, the personalized output 124 is provided as part of a webpage 130 that displays information associated with the query 122 and/or the personalized output 124. In addition, an interface for the virtual assistant module 118 is provided as a chat interface 132 to support the input of query 122 and output of at least a portion of the personalized output 124.

Chat interface 132 provides a unified task-based interface with text and audio input to receive customers' inputs 120 and provides personalized outputs 124. The virtual assistant module 118 determines a customer's context based on the data set 114 and responds to the queries 122 according to the context, intent, and sentiments associated with the input 120 to provide the personalized outputs 124.

The virtual assistant module 118 uses personalized LLMs to search and summarize events for customers to analyze and understand potential business impact. The summarization avoids a customer's utilizing manual search efforts to find relevant historical information by providing the historical information using personalized filtering criteria (e.g., product entitlements, location, event type, issue severity). Personalized customer experience through page view and subscription recommendations are also provided based on different methods like history, service association, product entitlements, and feedback.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Context-Aware AI Virtual Assistance

The following discussion describes context-aware AI virtual assistance techniques that are implementable utilizing the described systems and devices. Aspects of each procedure are implemented in hardware, firmware, software, or a combination thereof. The procedures are shown as a set of blocks that specify operations performable by hardware and are not necessarily limited to the orders shown for performing the operations by the respective blocks.

Blocks of the procedures, for instance, specify operations programmable by hardware (e.g., processor, microprocessor, controller, firmware) as instructions, thereby creating a special-purpose machine for carrying out an algorithm as illustrated by the flow diagram. As a result, the instructions are storable on a computer-readable storage medium that causes the hardware to perform the algorithm.

FIG. 2 depicts an example implementation of a virtual assistant module 118 of FIG. 1 in greater detail as employing techniques described herein for a context-aware AI virtual assistant. To begin in this example, context module 202 of the virtual assistant module 118 receives the input 120, including the query 122. The input 120, for instance, represents a text message (e.g., a plain language request entered into the chat interface 132), an audio message (e.g., a verbal request spoken by the user), a selection of one or more UI elements within the chat interface 132 containing the query 122, or a combination thereof. In one or more aspects, the query 122 received as natural language text is received (e.g., via the chat interface 132) from a prompt interface to one or more machine-learning models 204 of the virtual assistant module 118.

Generally, the context module 202 is operable to determine a context 206 based on the query 122 and output the context 206 and the query 122 to an intent module 208 of the virtual assistant module 118. The context module 202, in one or more implementations, shares an interface with the machine-learning models 204 and receives the context 206 inferred based on machine-learning techniques applied to the query 122. In another example, the context module 202 applies rule-based techniques to derive the context 206 of the query 122 or uses a combination of rule-based and machine-learning techniques to determine the context 206 of the query 122. Context 206 sets the stage for determining personalized responses inferable from query 122. By understanding the context 206, the virtual assistant module 118 can return results based on the query 122, which improves efficiency in analyzing the data set 114.

The context module 202 uses a product recommendation score (Pᵢ) to determine for which products the virtual assistant module 118 provides the personalized output 124. In one implementation, the personalized output 124 is provided for the N products or applications with the highest product recommendation scores, where N is a positive integer (e.g., N equals three). In one implementation, the product recommendation score (Pᵢ) is calculated using a sum of a response score, activity score, association score, entitlements score, and experience score (e.g., recent event feedback), where:

$$Activity Score ( {P}_{i} ) = \{ \begin{matrix}0 : & t = 0 \\ {\sum }_{t = 1}^{n} \frac{0.4}{{d}_{t}} : & t > 0\end{matrix}$$

$$Response Score ( {P}_{i} ) = \{ \begin{matrix}0 : & t = 0 \\ {\sum }_{t = 1}^{n} \frac{1}{{d}_{t}} : & t > 0\end{matrix}$$

where dt is the age (in days) of activity for a given product Pᵢ;

$$Association Score ( {P}_{i} , User ) = \{ \begin{matrix}0 : & User is associated to {P}_{i} \\ 1 : & User is not associated to {P}_{i}\end{matrix}$$

$$Entitlement Score ( {P}_{i} , User ) = \{ \begin{matrix}0 : & User is associated to {P}_{i} \\ 1 : & User is not associated to {P}_{i}\end{matrix}$$

$$Experience Score ( {P}_{i} , User ) = \{ \begin{matrix}0 : & {P}_{i} is part of feedback \\ 1 : & {P}_{i} is not part of feedback\end{matrix}$$

The intent module 208 determines an intent 210 of the query 122 using the machine-learning models 204. In general, the intent module 208 is configured to determine the user's intention with the query 122 to guide the machine-learning models 204. The intent 210 is output from the intent module 208 to a sentiment module 212 of the virtual assistant module 118, which determines a sentiment 214 of the query 122. In one implementation, the virtual assistant module 118 uses the machine-learning model 204 or another machine-learning model to identify the intent 210 and sentiment 214 associated with each query 122 that is passed back to the virtual assistant module 118.

The machine-learning model 204 receives at least two of the query 122, context 206, intent 208, and sentiment 214 and in response queries the services manager module 108 and the data set 114 based on the query 122. In general, the machine-learning models 204 are configured to cause the data reporting services 110 to query the data set 114 based on the query 122. As one example, the virtual assistant module 118 inputs the queries 122, context 206, intent 210, and sentiment 214 to the machine-learning model(s) 204. The machine-learning model 204 shares an interface with the services manager module 108, from which the data reporting services 110 are instructed by the machine-learning model 204 to query the data set 114 using the query 122. The summary module 216 receives results and data in response to each query 122 to generate summaries for the personalized output 124. The personalized output 124 includes one or more of an answer 218 (e.g., a textual response to the query 122), recommendation 220 (e.g., recommended page, product, or action to address the user's query 122), summary 222 (e.g., concise description of CSO or CMR history and events), subscription assistance 224 (e.g., help to subscribe or unsubscribe from products or services), redirection 226 (e.g., link to support pages or customer support personnel), and view 228 (e.g., summary of event history or current subscriptions) as exemplified by FIGS. 3A through 3F.

In one or more variations, the machine-learning model 204 is trained or re-trained based on the data set 114 to respond directly to the queries 122. In at least one other variation, the machine-learning model 204 is trained or re-trained based on information provided by the services manager module 108 and/or the data reporting services 110 on how to communicate with the data reporting services 110 to query the data set 114 and respond to the queries 122 with personalized outputs 124 that answer the queries 122. For example, an application programming interface to the data reporting services 110 and/or the data set 114 is used to obtain training data for configuring the machine-learning model 204 to be able to query the data set 214 managed by the services manager module 108.

FIGS. 3A, 3B, 3C, 3D, 3E, and 3F illustrate examples of user interfaces for a context-aware AI virtual assistant as described herein. In particular, the virtual assistant module 118 provides personalized outputs 124 relevant to the customer and the received queries 122. As a first example, FIG. 3A and FIG. 3B illustrate example implementations 300 and 310, respectively, of the virtual assistant module 118 providing context-aware updates. In FIG. 3A, the user interface 302 provides an overview page providing a summary of major issues, maintenance completed, maintenance canceled, software availability, pending issues, and event updates relevant to the customer. The user interface 302 also includes the chat interface 132 associated with the virtual assistant module 118 allowing the user to select frequently-chosen actions as user-interface (UI) buttons 304 or enter a message 306. In FIG. 3B, the user interface 312 is updated in response to the user clicking on the “want to know updates on maintenance and issues” UI button 314. The virtual assistant module 118 provides a personalized “your events” link via the chat interface 132.

In another implementation, the virtual assistant module 118 displays the customer's subscriptions reactively or proactively based on the customer's entitlements and subscriptions. The virtual assistant module 118 also assists customers in subscribing and unsubscribing to products based on inputs without going through a multiple-step subscription process, which often includes multiple clicks and navigation efforts. FIG. 3C illustrates an example implementation 320 of the virtual assistant module 118 providing improved subscription services. For example, the user interface 322 provides a subscription flow executed via the chat interface 132. In response to the user selecting “want to change subscriptions for proactive updates” (or a similar UI button) or providing a message with a similar intent, the virtual assistant module 118 asks whether the user wants to subscribe or unsubscribe to products. In response to the user selecting “subscribe,” the chat interface 132 is updated with a dropdown list 324 (or a similar UI interface) to allow the selection of one or more products. In the illustrated implementation 320, the user selects to subscribe to “Adobe Acrobat Sign” and “Acrobat” and the virtual assistant module 118 asks the user to confirm the selection.

The virtual assistant module 118 also addresses customer-facing issues and provides summary information regarding the potential business impact. For example, the virtual assistant module 118 provides an AI-generated summary of the existing issues for a specific product or collection of products without the user navigating for the desired information. FIG. 3D illustrates an example implementation 330 of the virtual assistant module 118 summarizing customer-facing issues. In FIG. 3D, the user interface 332 summarizes issues related to a user-selected software product 334 in the chat interface 132.

In another example, the virtual assistant module 118 assists customers in identifying and contacting the correct support personnel for particular issues. In this way, the virtual assistant module 118 provides a single place for customer support, redirecting customers to the right support channels. FIG. 3E illustrates an example implementation 340 of the virtual assistant module 118, assisting users in finding the correct support channels. In FIG. 3E, in response to the user identifying a particular product 344 for which assistance is requested, the user interface 342 provides a link 346 for the user to contact the correct support channel.

The virtual assistant module 118 provides an AI-generated summary of current and/or historical CSOs and CMRs based on a customer's intent. FIG. 3F illustrates an example of implementation 350 of the virtual assistant module 118 providing current and historical CSOs without requiring the customer to navigate multiple product pages or apply filters to obtain the desired information. In FIG. 3F, the user interface 352 filters information particular to the user and the chat interface 132 provides a summary 354 of each relevant CSO. If no events are related to the customer query, the virtual assistant module 118 redirects the customer to appropriate channels based on the query's sentiment (e.g., positive, neutral, or negative). Further discussion of these and other examples is included in the following section and shown in the corresponding figures.

FIG. 4 illustrates an example implementation 400 of guardrails for the context-aware AI virtual assistant as described herein. The implementation 400 includes a machine-learning system 402 that utilizes input guardrails 404 and output guardrails 406 to detect, quantify, and mitigate various risks, including harm and bias. A machine-learning model implements the input guardrails 404 and output guardrails 406 to identify potential risks and harm. In some implementations, the machine-learning model for the guardrails is part of the support system 116 to allow multiple digital services to check for risks and harm in the input 120 or the personalized output 124. In other implementations, this machine-learning model is an external machine-learning model.

To begin, the machine-learning system 402 receives a prompt 408, which includes the input 120 with the query 122. Before the prompt 408 is provided to the machine-learning model 204, the machine-learning system 402 utilizes the input guardrails 404 to check for potential harm or risk. The input guardrails 404 include an analysis of the prompt 408 for personally identifiable information (PII) 410, an off-topic request 412, or a jailbreak attempt 414. For instance, the input guardrails 404 analyzes the prompt 408 to minimize exposure to harmful and offensive content and ensure a diverse representation of people, cultures, and identities in virtual assistance. The input guardrails also analyses prompt 408 to identify and mitigate unintended consequences. Examples of unintended consequences include unexpected results that could return a harmful result based on the language. The input guardrails 404 prevent intentional system abuse through jailbreak attempts 414 by screening inputs designed to purposely cause the virtual assistant module 118 to generate harmful or negative responses. Similarly, the input guardrails 404 keeps the virtual assistant module 118 on topic and within its designed parameters by identifying off-topic requests 412.

In one implementation, the input guardrails 404 use block-and-deny lists to reduce the possibility of harmful content being generated by the machine-learning system 402. Block-and-deny lists include a curated list of words for which a machine-learning model is expressly instructed to avoid generating outputs, including PII 410. In response to a blocked prompt, the machine-learning system 402 generates an error message or alert instead of generating the personalized output 124. In another implementation, a denied prompt leads to a personalized output 124 with the suppressed word removed. If prompt 408 does not include blocked or denied content, prompt 408 is passed through the input guardrails 404 to machine-learning model 204.

As described above with respect to FIGS. 1 and 2, the machine-learning model 204 of the virtual assistant module 118 generates an output 416 (e.g., the personalized output 124). Before the output 416 is provided to the user, the machine-learning system 402 utilizes the output guardrails 406 to identify potential harm, bias, or risks. In particular, the output guardrails 406 analyze the output 416 for a competitor mention 418, profanity 420, or hallucinations 422. The competitor mention 418 ensures the output 416 is focused on the provider's software and applications and does not provide support or information for competitor products.

The output guardrails 406 use classifiers and filters to reduce instances of graphic or Not Safe for Work content in the form of profanity 420. The output guardrails 406 evaluate whether those instances are blocked harmful terms that did not appear in block-and-deny lists. In addition, output guardrails 406 consider whether the generated caption contains exploitative or hateful content. In other instances, the output guardrails 406 use debiasing tools to intentionally reduce bias in outputs generated by machine-learning models 204 regarding how humans are represented and portrayed. By applying country or cultural specifics to prompts, stereotypes and misrepresentation are reduced.

The output guardrails 406 also monitor for hallucinations 422 in the output 416. Hallucinations 422 include incorrect, misleading, or nonsensical content generated by the machine-learning models 204, which can occur due to insufficient training data related to a particular prompt 408, overfitting, bias, or exploitative prompts 408. The output guardrails 406 implement mechanisms to verify the accuracy of the outputs 416 by cross-referencing with the data set 114. Once the output 416 passes the output guardrails 406, the machine-learning system 402 provides the filtered or verified output as the personalized output 124.

FIG. 5 is a flow diagram depicting an algorithm as a step-by-step procedure 500 in an example implementation of operations performable for training a machine-learning model of the support system 116 of FIG. 1. The procedure 500 provides one or more examples of generating training data, use of the training data to train a machine-learning model, and use of the trained machine-learning model to perform a task.

To begin in this example, the support system 116 collects training data (block 502) to be used as a basis to train a machine-learning model (e.g., machine-learning models 204), i.e., which defines what is being modeled. The training data is collectible by the support system 116 from a variety of sources, including the dataset described 114 in relation to FIG. 1. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance several positive and negative examples, and so forth.

The support system 116 is also configurable to identify relevant features (block 504) to a task type for which the machine-learning model is to be trained. Task examples include classification, natural language processing, generative artificial intelligence, recommendation engines, reinforcement learning, clustering, and so forth. To do so, the support system 116 collects the training data based on the identified features and/or filters the training data based on the identified features after collection. The training data is then utilized to train a machine-learning model.

In order to train the machine-learning model in the illustrated example, the machine-learning model is first initialized (block 506). Initialization of the machine-learning model includes selecting a model architecture (block 508) to be trained. Examples of model architectures include large language models (LLMs), neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

In this context, the machine-learning model uses an LLM to understand, generate, and interact with human language inputs (e.g., query 122). These machine-learning models are trained on vast amounts of text data using deep learning techniques (e.g., neural networks) to learn patterns, nuances, and the structure of language. The term “large” in LLMs refers to the training data's size and the neural networks' complexity and scale, which may include billions or even trillions of parameters.

As described above, LLMs are configurable to perform a wide range of language-related tasks without being explicitly programmed for each one. To train the LLM, the underlying machine-learning model is provided with training data that includes examples of text to train and retrain the model to predict the next word in a sequence. Over time, the model, once trained, is configured to generate text that is coherent, contextually relevant, and mimics the style and content of the training data, and so forth.

A loss function is also selected (block 510). The loss function is utilized to measure a difference between an output of the machine-learning model (i.e., predictions) and target values (e.g., as expressed by the training data) to be used to train the machine-learning model. Additionally, an optimization algorithm is selected (block 512) to be used in conjunction with the loss function to optimize parameters of the machine-learning model during training, examples of which include gradient descent, stochastic gradient descent (SGD), and so forth.

Initialization of the machine-learning model further includes setting hyperparameters and initial values of the machine-learning model (blocks 514 and 516), examples of which include initializing weights and biases of nodes to improve efficiency in training and computational resource consumption as part of training. Hyperparameters are also set to control the training of the machine learning model, examples include regularization parameters, model parameters (e.g., a number of layers in a neural network), learning rate, batch sizes selected from the training data, and so on. The hyperparameters are set using various techniques, including the use of a randomization technique, the use of heuristics learned from other training scenarios, and so forth.

The machine-learning model is then trained using the training data (block 518) by the support system 116. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from and make predictions on known data by analyzing training data to learn and relearn to generate outputs that reflect patterns and attributes expressed by the training data.

Examples of training types include supervised learning that employs labeled data, unsupervised learning that involves finding underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through the use of the selected loss function and backpropagation to optimize the performance of the machine-learning model to perform an associated task.

As part of training the machine-learning model, a determination is made as to whether a stopping criterion is met (decision block 520), which is used to validate the model. The stopping criterion is usable to reduce the overfitting of the machine-learning model, reduce computational resource consumption, and promote the ability of the machine-learning model to address previously unseen data (e.g., data not included specifically as an example in the training data). Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 520), the procedure 500 continues training of the machine-learning model using the training data (block 518) in this example.

If the stopping criterion is met (“yes” from decision block 520), the trained machine-learning model is then utilized to generate an output based on subsequent data (block 522) (e.g., to generate the personalized outputs 124). The trained machine-learning model, for instance, is trained to perform a task as described above and therefore once trained is configured to perform that task based on subsequent data received as input and processed by the machine-learning model.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable individually, together, and/or combined in different ways. Thus, individual functionality, features, and concepts described in relation to different example environments, devices, components, figures, and procedures herein are usable in any suitable combinations and are not limited to the particular combinations represented by the enumerated examples in this description.

### Example Procedures

The following discussion describes techniques which are implementable utilizing the previously described systems and devices. Aspects of each of the procedures are implementable in hardware, firmware, software, or a combination thereof. The procedures are shown as a set of blocks that specify operations performed by one or more devices and are not necessarily limited to the orders shown for performing the operations by the respective blocks. In portions of the following discussion, reference is made to FIGS. 1-5. FIG. 6 is a flow diagram depicting a procedure in an example implementation for context-aware AI virtual assistance.

To begin, a processing device receives an input including a query related to support services for one or more products (block 602). For example, the input 120 with the query 122 is received from or via a prompt interface (e.g., the chat interface 136) of the virtual assistant module 118. The chat interface 136 receives the input 120 as a text message as either a typed message or as a selection of a displayed UI button with a particular text query, an audio message, or a combination thereof.

The processing device queries a machine-learning model using the query and a context of the query (block 604). For example, the context 206 includes one or more current subscriptions of the user or associated with the user (e.g., IT personnel for a business entity) or one or more products mentioned in the query 122. The context 206 also includes identifying an intent 210 or a sentiment 214 inferred from the input 120. The machine-learning model 204 uses the intent and the sentiment to provide the personalized output 124 (e.g., a summary description of outages, issues, or maintenance events associated with the subscriptions or a redirection link for a support channel) based on the intent 210 or the sentiment 214. As described above, the machine-learning model 204 is trained using structured training data for text summarization with positive sentiments and includes input and output guardrails to moderate the input 120 and the personalized output 124.

A result including an answer to the query based on the context is then received from the machine-learning model (block 606). For example, the result or personalized output 124 includes a simplified subscription or unsubscribe process (e.g., subscription assistance 222) within the chat interface 136 to allow the user to quickly and efficiently add or remove products from their subscriptions. In other examples, the personalized output includes a redirection link for a support channel associated with the subscriptions, a summary of the subscriptions, announcements related to the subscriptions, and a summary description of outages, issues, or maintenance events associated with the subscriptions.

The processing device then presents the result for display in a user interface (block 608). For example, the personalized output 124 from the machine-learning model 204 of the virtual assistant module 118 is provided as a text response in a natural language format within the chat interface 136.

### Example System and Device

FIG. 7 illustrates an example system 700 that includes an example computing device that is representative of one or more computing systems and/or devices that are usable to implement the various techniques described herein. This is illustrated through inclusion of the virtual assistant module 118. The computing device 702 includes, for example, a server of a service provider, a device associated with a client (e.g., a client device), an on-chip system, and/or any other suitable computing device or computing system.

The example computing device 702 as illustrated includes a processing system 704, one or more computer-readable media 706, and one or more I/O interfaces 708 that are communicatively coupled, one to another. Although not shown, the computing device 702 further includes a system bus or other data and command transfer system that couples the various components, one to another. For example, a system bus includes any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 704 is representative of functionality to perform one or more operations using hardware. Accordingly, the processing system 704 is illustrated as including hardware elements 710 that are configured as processors, functional blocks, and so forth. This includes example implementations in hardware as an application specific integrated circuit or other logic device formed using one or more semiconductors. The hardware elements 710 are not limited by the materials from which they are formed or the processing mechanisms employed therein. For example, processors are comprised of semiconductor(s) and/or transistors (e.g., electronic integrated circuits (ICs)). In such a context, processor-executable instructions are, for example, electronically-executable instructions.

The computer-readable media 706 is illustrated as including memory/storage 712. The memory/storage 712 represents memory/storage capacity associated with one or more computer-readable media. In one example, the memory/storage 712 includes volatile media (such as random access memory (RAM)) and/or nonvolatile media (such as read only memory (ROM), Flash memory, optical disks, magnetic disks, and so forth). In another example, the memory/storage 712 includes fixed media (e.g., RAM, ROM, a fixed hard drive, and so on) as well as removable media (e.g., Flash memory, a removable hard drive, an optical disc, and so forth). The computer-readable media 706 is configurable in a variety of other ways as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which employs visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 702 is configurable in a variety of ways as further described below to support user interaction. In other implementations, the computing device 702 is also configurable to support machine-to-machine (M2M) interactions for which application programmable interfaces (APIs) can be provided by the system 700.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are implementable on a variety of commercial computing platforms having a variety of processors.

Implementations of the described modules and techniques are storable on or transmitted across some form of computer-readable media. For example, the computer-readable media includes a variety of media that is accessible to the computing device 702. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which are accessible to a computer.

“Computer-readable signal media” refers to a signal-bearing medium that is configured to transmit instructions to the hardware of the computing device 702, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of modules, programmable device logic and/or fixed device logic implemented in a hardware form that is employable in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also employable to implement various techniques described herein. Accordingly, software, hardware, or executable modules are implementable as one or more instructions and/or logic embodied on some form of computer-readable storage media and/or by one or more hardware elements 710. For example, the computing device 702 is configured to implement particular instructions and/or functions corresponding to the software and/or hardware modules. Accordingly, implementation of a module that is executable by the computing device 702 as software is achieved at least partially in hardware, e.g., through use of computer-readable storage media and/or hardware elements 710 of the processing system 704. The instructions and/or functions are executable/operable by one or more articles of manufacture (for example, one or more computing devices 702 and/or processing systems 704) to implement techniques, modules, and examples described herein.

The techniques described herein are supportable by various configurations of the computing device 702 and are not limited to the specific examples of the techniques described herein. This functionality is also implementable entirely or partially through use of a distributed system, such as over a “cloud” 714 as described below.

The cloud 714 includes and/or is representative of a platform 716 for resources 718. The platform 716 abstracts underlying functionality of hardware (e.g., servers) and software resources of the cloud 714. For example, the resources 718 include applications and/or data that are utilized while computer processing is executed on servers that are remote from the computing device 702. In some examples, the resources 718 also include services provided over the Internet and/or through a subscriber network, such as a cellular or Wi-Fi network.

The platform 716 abstracts the resources 718 and functions to connect the computing device 702 with other computing devices. In some examples, the platform 716 also serves to abstract scaling of resources to provide a corresponding level of scale to encountered demand for the resources that are implemented via the platform. Accordingly, in an interconnected device embodiment, implementation of functionality described herein is distributable throughout the system 700. For example, the functionality is implementable in part on the computing device 702 as well as via the platform 716 that abstracts the functionality of the cloud 714.

In some aspects, the techniques described herein relate to a method including: receiving, by a processing device, input data describing attributes of an entity segment and keywords that are associated with the attributes of the entity segment; determining, by the processing device, additional keywords from a keyword corpus that are semantically similar to the keywords using a machine-learning model trained on training data to classify semantically similar keywords; compiling, by the processing device, a set of matchable keywords that includes the keywords and the additional keywords; identifying, by the processing device, candidate instances of digital content from a content repository based on content keywords assigned to the candidate instances of digital content and the set of matchable keywords; and generating, by the processing device, an indication of an instance of digital content for display in a user interface based on the candidate instances of digital content.

What is claimed is:

1. A method comprising:
receiving, by a processing device, an input including a query related to support services for one or more products;
querying, by the processing device, a machine-learning model using the query and a context of the query, the context including a subscription status of a user for the one or more products;
receiving, by the processing device from the machine-learning model, a result including an answer to the query based on the context; and
presenting, by the processing device, the result for display in a user interface.

2. The method of claim 1, wherein the input is received from a prompt interface to the machine-learning model.

3. The method of claim 2, wherein the prompt interface includes a chat interface configured to receive the input as a text message or an audio message and provide the result as text responses in a natural language format.

4. The method of claim 3, wherein the context further includes one or more subscriptions of a user for the one or more products and the result includes a simplified subscription process or a simplified unsubscribe process within the chat interface.

5. The method of claim 3, wherein the result includes a redirection link for a support channel associated with the one or more subscriptions.

6. The method of claim 1, wherein the context further includes one or more subscriptions of a user and the result includes a summary of the one or more subscriptions, one or more announcements related to the one or more subscriptions, and a summary description of one or more outages, issues, or maintenance events associated with the one or more subscriptions.

7. The method of claim 6, wherein:
the method further comprises identifying, by the processing device, the context of the query as an intent or a sentiment inferred from the input; and
the result includes the summary description of the one or more outages, issues, or maintenance events associated with the one or more subscriptions or a redirection link for a support channel associated with the one or more subscriptions based on the intent or the sentiment.

8. The method of claim 1, wherein the machine-learning model is trained using structured training data for text summarization with positive sentiments.

9. The method of claim 1, wherein the machine-learning model includes input guardrails to assess the input for at least one of personally identifying information, off-topic requests, or jailbreak attempts.

10. The method of claim 9, wherein the machine-learning model includes output guardrails to assess an output from the machine-learning model for at least one of a competitor mention, profanity, or hallucinations before providing the result via the user interface.

11. A system comprising:
a data storage configured to maintain a data set related to one or more products; and
one or more processing devices communicatively coupled to the data storage to perform operations that include:
receive an input from a user including a query related to support services for the one or more products;
query, using a machine-learning model, the data set based on the query and a context of the query, the context including one or more subscriptions of the user;
receive, from the machine-learning model, a result including an answer to the query based on the context; and
present the result for display in a user interface.

12. The system of claim 11, wherein the input is received from a prompt interface that includes a chat interface to the machine-learning model.

13. The system of claim 12, wherein the chat interface configured to receive the input as a text message or an audio message and provide the result as text responses in a natural language format.

14. The system of claim 11, wherein a subset of the one or more products for the context are identified based on an activity of each product, an association of each product to the user, and recent feedback associated with each product.

15. The system of claim 11, wherein the result includes a summary of the one or more subscriptions, one or more announcements related to the one or more subscriptions, and a summary description of one or more outages, issues, or maintenance events associated with the one or more subscriptions.

16. The system of claim 15, wherein:
the context of the query further includes an intent or a sentiment inferred from the input; and
the result includes the summary description of the one or more outages, issues, or maintenance events associated with the one or more subscriptions or a redirection link for a support channel associated with the one or more subscriptions based on the intent or the sentiment.

17. The system of claim 11, wherein the machine-learning model is trained using structured training data for text summarization with positive sentiments.

18. The system of claim 11, wherein the machine-learning model includes input guardrails to assess the input for at least one of personally identifying information, off-topic requests, or jailbreak attempts.

19. The system of claim 18, wherein the machine-learning model includes output guardrails to assess an output from the machine-learning model for at least one of a competitor mention, profanity, or hallucinations before providing the result via the user interface.

20. A non-transitory computer-readable medium storing executable instructions, which when executed by a processing device, cause the processing device to perform operations comprising:
receiving, by a processing device, an input including a query related to support services for one or more products;
querying, by the processing device, a machine-learning model using the query and a context of the query, the context including a subscription status of a user for the one or more products;
receiving, by the processing device from the machine-learning model, a result including an answer to the query based on the context; and
presenting, by the processing device, the result for display in a user interface.
